(19) United States
(12) Patent Application Publication
(10) Pub. No.: US 2012/0171002 A1
(43) Pub. Date: Jul. 5, 2012

(54) APPARATUS AND METHOD FOR TRANSFERRING A SUBSTRATE

(75) Inventors: Kyung Young KIM, Portland, OR (US); Seunghoon LEE, Osan-si (KR)

(73) Assignee: ELECTRO SCIENTIFIC INDUSTRIES, INC, Portland, OR (US)

(21) Appl. No.: 13/343,540

(22) Filed: Jan. 4, 2012

Related U.S. Application Data
(60) Provisional application No. 61/430,039, filed on Jan. 5, 2011.

(51) Int. Cl. B65G 49/00

(52) U.S. Cl. 414/222.01; 414/806

(57) ABSTRACT

A substrate transfer apparatus includes upper and lower substrate support systems configured to support a substrate at upper and lower support levels, respectively, within a process chamber. A substrate elevator system is configured to move the substrate between the upper and lower support levels. A transfer robot for transferring substrates into and out of the process chamber, a loadlock chamber and methods of transferring substrates are also disclosed.

### CROSS REFERENCE TO RELATED APPLICATIONS

This application claims the benefit of U.S. Provisional application No. 61/430,039, filed Jan. 5, 2011, the contents of which are incorporated herein by reference.

### BACKGROUND

Embodiments of the present invention as exemplarily described herein relate generally to apparatuses and methods for transferring substrates. More particularly, embodiments of the present invention relate to apparatuses and methods capable of transferring substrates into and out of process chambers with increased efficiency.

To increase throughput of a process chamber, the time it takes to remove a processed substrate from the process chamber and insert an unprocessed substrate into the process chamber for processing (i.e., a “substrate swapping time”) can be reduced. One conventional process of swapping substrates involves using a dual-axis transfer robot (e.g., disposed within a loadlock) having two end effectors (also known as a “dual arm robot”). An example of such a process can include moving the transfer robot in a horizontal direction to remove a processed substrate from the process chamber (e.g., through a process chamber port) onto a first end effector, moving the robot in a vertical direction to align a second end effector with the process chamber port, and moving the transfer robot in a horizontal direction to insert an unprocessed substrate into the process chamber (e.g., through the process chamber port).

While using a dual-axis, dual arm transfer robot can, in some cases, reduce a substrate swapping time, using such a transfer robot can be costly. Further, depending on the design of process chamber, the substrate swapping time will depend not only upon the time required to remove a processed substrate and insert an unprocessed substrate, but is also affected by the amount of time required to post-process or pre-process a substrate. Post- and pre-processing can be performed in the loadlock. However the dual-axis, dual-arm transfer robot described above tends to requires a relatively large loadlock, resulting in less efficient post- and pre-processing of substrates within the loadlock. Nevertheless, in a substrate processing system including a process chamber coupled to a loadlock, five sequential process steps are required to swap a processed substrate for an unprocessed substrate, including: (1) remove the processed substrate, (2) post-process the processed substrate in the loadlock, (3) remove the post-processed substrate from the loadlock and/or insert an unprocessed substrate into the loadlock, (4) pre-process the unprocessed substrate in the loadlock, and (5) insert the pre-processed substrate into the process chamber. When substrates are provided as 300 mm semiconductor wafers each supported by a tape frame assembly, the time necessary to perform steps (1) to (5) can take more than 3 minutes if a dual-axis, dual-arm transfer robot is not incorporated within the loadlock.

### SUMMARY

In one embodiment, a substrate transfer apparatus may include an upper substrate support system configured to be disposed within a substrate process chamber. The upper substrate support system may include at least one upper substrate support configured to support a substrate at a upper support level. The substrate transfer apparatus may further include a lower substrate support system including at least one lower substrate support configured to support the substrate at a lower support level below the upper support level and a substrate elevator system including configured to move substrate between the upper support level and the lower support level. The upper substrate support system and the substrate elevator system can be configured such that the substrate is transferrable from the at least one upper substrate support to the substrate stage. The lower substrate support system and the substrate elevator system can be configured such that the substrate is transferrable from the substrate stage to the at least one lower substrate support.

In another embodiment, a method of transferring substrates can include providing a process chamber having a first substrate support system and a second substrate support system within an interior thereof, wherein each of the first substrate support system and second substrate support system are configured to support a substrate; transferring a first substrate onto the first substrate support system such that the first substrate is supported by the first substrate support system; inserting a first end effector supporting a second substrate into the process chamber such that the first substrate, first end effector and second substrate are simultaneously disposed within the process chamber; inserting a second end effector into the process chamber such that the first substrate, first end effector, second substrate and second end effector are simultaneously disposed within the process chamber; transferring the first substrate onto the second end effector; removing the first end effector from the process chamber after transferring the second substrate onto the first substrate support system; and removing the second end effector from the process chamber after transferring the first substrate onto the second end effector.

### BRIEF DESCRIPTION OF THE FIGURES

FIG. 1 is a front view schematically illustrating a substrate transfer apparatus according to one embodiment.

FIG. 2 is a side view of the substrate transfer apparatus shown in FIG. 1.

FIG. 3 is a side view schematically illustrating of a transfer robot having end effectors that may be used with the substrate transfer apparatus shown in FIGS. 1 and 2.

FIG. 4 is a front view schematically illustrating an upper support actuation system according to one embodiment.

FIG. 5 is a side view schematically illustrating a lower support actuation system according to one embodiment.

FIGS. 6 and 7 schematically illustrate one embodiment of a method of transferring a substrate from an end effector onto the upper substrate support system in the substrate transfer apparatus shown in FIGS. 1 and 2.

FIGS. 8 and 9 schematically illustrate one embodiment of a method of transferring a substrate from the upper substrate support system to a process region of a process chamber.

FIGS. 10 to 12 schematically illustrate one embodiment of a method of transferring a substrate from the substrate elevator system in the substrate transfer apparatus shown in FIGS. 1 and 2 to an end effector.

### DETAILED DESCRIPTION OF THE ILLUSTRATED EMBODIMENTS

The invention is described more fully hereinafter with reference to the accompanying drawings, in which example embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

It will be understood that, although the terms first, second, third, etc., may be used herein to describe various elements, components, regions, sets, ends, paths, etc., these elements, components, regions, sets, should not be limited by these terms. These terms are only used to distinguish one element, component, region, set, end, path, etc., from another element, component, region, set, end, path, etc. Thus, a first element, component, region, set, end, path, etc., discussed below could be termed a second element, component, region, set, end, path, etc., without departing from the teachings provided herein.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, ends, paths, and/or groups thereof.

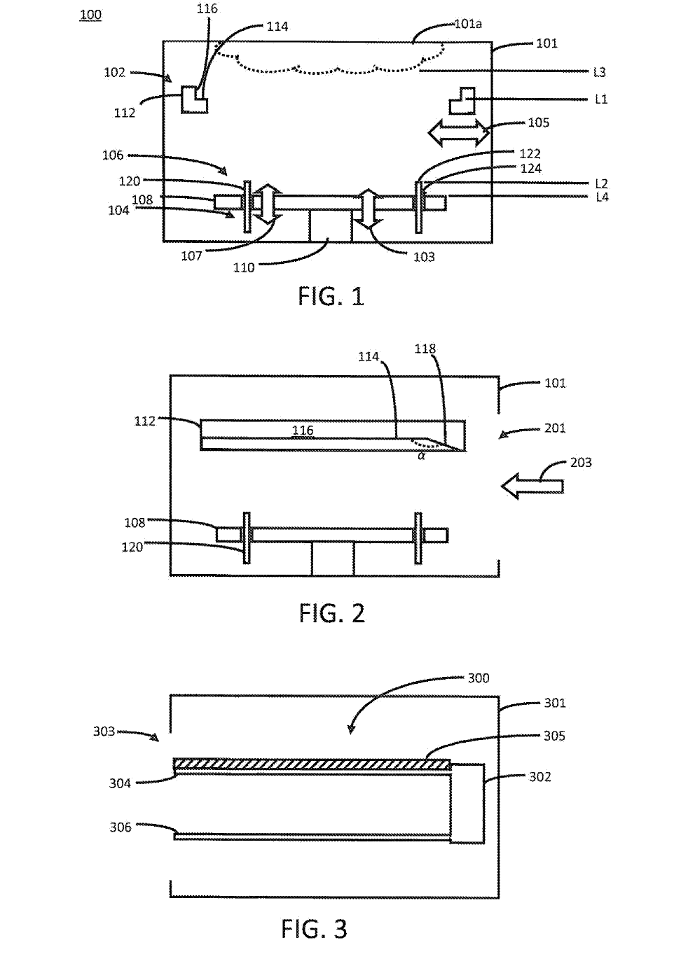

FIG. 1 is a front view schematically illustrating a substrate transfer apparatus according to one embodiment. FIG. 2 is a side view of the substrate transfer apparatus shown in FIG. 1.

Referring to FIGS. 1 and 2, a substrate transfer apparatus, such as substrate transfer apparatus 100, may be disposed within a process chamber 101. Generally, the substrate transfer apparatus 100 is configured to transfer substrates between a process region 101a of the process chamber and a transfer robot (not shown).

The process chamber 101 can be any type of process chamber known in the art. For example, the process chamber 101 can be provided as a chemical vapor deposition (CVD) chamber (e.g., an atmospheric pressure CVD chamber, a low pressure CVD chamber, an ultrahigh vacuum CVD chamber, an aerosol assisted CVD chamber, a direct liquid injection CVD chamber, a plasma enhanced CVD chamber, an atomic layer CVD chamber, a metallogranic CVD chamber, a rapid thermal CVD chamber, etc.), a physical vapor deposition (PVD) chamber (e.g., a sputter PVD chamber, a pulsed laser PVD chamber, an evaporative deposition PVD chamber, etc.), an etch chamber (e.g., a plasma etch chamber, a reactive ion etch chamber, etc.), or the like. Generally, however, the process chamber 101 is configured to perform a process (e.g., a deposition process, an etching process, an annealing process, or the like or a combination thereof) on a substrate that is disposed within a process region (e.g., exemplarily illustrated at region 101a). Thus, the process chamber 101 is configured to process a substrate when the substrate is disposed within the process region 101a. Although the substrate transfer apparatus 100 is illustrated as being disposed within the process chamber 101, it will be appreciated that the substrate transfer apparatus may be disposed outside the process chamber 101, but still communicate with the interior of the process chamber so as to transfer substrates to and from the process region 101a.

As exemplarily illustrated, the substrate transfer apparatus 100 includes an upper substrate support system 102 configured to support a substrate at a upper support level L1, a lower substrate support system 104 configured to support a substrate at a lower support level L2 below the upper support level L1, and a substrate elevator system 106 having a substrate stage 108 configured to support a substrate between the upper support level L1 and the lower support level L2. In one embodiment, the substrate stage 108 may be provided as a chuck such as a vacuum chuck, an electrostatic chuck, or the like or a combination thereof. The substrate elevator system 106 may further include a stage elevator 110 configured to move the substrate stage 108 between the upper support level L1 and the lower support level L2 (e.g., generally along directions indicated by arrow 103).

The upper substrate support system 102 includes a plurality of upper substrate supports or rails 112 spaced apart from each other and configured to support a substrate at the upper support level L1. For example, each upper substrate support 112 can include a support surface 114 disposed at the upper support level L1 and configured to contact a surface (e.g., a lower surface) of a substrate to thereby support the substrate. In one embodiment, each upper substrate support 112 can include a guide surface 116 extending upwards from the upper support level L1 and configured guide movement of the substrate along the length of the support surface 114. In another embodiment, each upper substrate support 112 can include a transfer surface 118 extending downwards from upper support level L1 and is disposed at an angle, α, relative to the support surface 114. Generally, a is greater than 90 degrees and less than 180 degrees. For example, a can be greater than 110 degrees and less than 160 degrees. Because the transfer surface 118 is slanted relative to the support surface 114, the transfer surface 118 can engage a substrate inserted into the process chamber 101 (e.g., through a process chamber port 201 along a direction exemplarily indicated by arrow 203) within a first transfer region at a level below the upper support level L1. Upon engaging the substrate, the transfer surface 118 can deflect the moving substrate above the upper support level L1 and over the support surface 114, but unsupported by the support surface 114. When the mass of the portion of the substrate extending over (and unsupported by) the support surface 114 exceeds the mass of the remaining portion of the substrate, the substrate falls onto the support surface 114 where it supported at the upper support level L1.

The lower substrate support system 104 includes a plurality of lower substrate supports or pins 120 spaced apart from each other and configured to support a substrate at the lower support level L2. For example, an end 122 of each lower substrate support 120 defines a support surface 122 disposed at the lower support level L2 and configured to contact a surface (e.g., a lower surface) of a substrate to thereby support the substrate.

In one embodiment, and as will be discussed in greater detail below, the stage elevator 110 may be further configured to move the substrate stage 108 to a process level (e.g., exemplarily illustrated at level L3) above the upper support level L1. When the substrate stage 108 is moved to the process level L3, a substrate supported by the substrate stage 108 can be disposed within the process region 101a.

Generally, the upper substrate support system 102, the substrate elevator system 106, or a combination thereof, can be configured such that a substrate is transferrable from the upper substrate supports 112 to the substrate stage 108. For example, at least one of the upper substrate supports 112 is movable relative to the substrate stage 106 (e.g., generally along the directions indicated by arrow 105). As will be described below in greater detail, at least one of the upper substrate supports 112 can be movable relative to the substrate stage 106 from a first upper support position (illustrated) in which a substrate is supportable at the upper support level L1 to a second upper support position in which a substrate is transferrable to the substrate stage 108. In another embodiment, and as will be described in greater detail below, the upper substrate support system 102 may include an upper support actuation system (not shown) configured to move at least one of the upper substrate supports 112 from the second upper support position to the first upper support position. It will nevertheless be appreciated that the upper substrate support system 102 and/or the substrate elevator system 106 may be configured differently in any manner desired to permit a substrate to be transferred from the upper substrate supports 112 to the substrate stage 106.

Generally, the lower substrate support system 104, the substrate elevator system 106, or a combination thereof, can be configured such that a substrate is transferrable from the substrate stage 108 to the lower substrate supports 120. For example, the stage elevator 110 may be further configured to move the substrate stage 108 to a transfer level (e.g., exemplarily illustrated at level L4) below the lower support level L2. In one embodiment, the substrate stage 108 may include a plurality of apertures 124, wherein the end 122 of at least one of the lower substrate supports 120 is movable through at least a portion of the length of an aperture 124. Thus, when the substrate stage 108 is moved to the transfer level L4, a substrate supported by the substrate stage 108 can be supported at the lower support level L2 by the lower substrate supports 120. It will nevertheless be appreciated that the lower substrate support system 104 and/or the substrate elevator system 106 may be configured differently in any manner desired to permit a substrate to be transferred from the substrate stage 108 to the lower substrate supports 120.

As will be described in greater detail below, a second transfer region is definable between the transfer level L4 and the lower support level L2 and the plurality of second substrate supports 120 are configured such that a portion of an end effector (not shown) is receivable within the second transfer region. Further, the lower substrate supports 120 can be movable relative to the substrate stage 108 (e.g., generally along directions indicated by arrow 107) from a first lower support position (illustrated) in which the ends 122 are disposed at the lower support level L2 to a second lower support position below the aforementioned second transfer position. In one embodiment, the second lower support position is below the transfer level L4. By moving the ends 122 of the lower substrate supports 120 from the first lower support position to the second lower support position, a substrate supported by the lower substrate support system 104 can be transferred to an end effector disposed within the second transfer region.

As will be described in greater detail below, the lower substrate support system 104 may include a lower support actuation system (not shown) configured to move at least one of the lower substrate supports 120 from the first lower support position to the second lower support position. In one embodiment, the lower support actuation system may be actuatable to move the lower substrate supports 120 from the first lower support position to the second lower substrate support position when the portion of the end effector is disposed within the second transfer region. In another embodiment, the substrate elevator system 106 may be configured to actuate the lower support actuation system to move the lower substrate supports 120 from the second lower support position to the first lower substrate support position. It will nevertheless be appreciated that the lower support actuation system and/or the substrate elevator system 106 may be configured differently in any manner desired to permit a substrate to be transferred from the lower substrate support system 104 to an end effector disposed within the second transfer region.

FIG. 3 is a side view schematically illustrating of a transfer robot having end effectors that may be used with the substrate transfer apparatus shown in FIGS. 1 and 2.

Referring to FIG. 3, a transfer robot, such as transfer robot 302, may be disposed within a loadlock chamber 301 having a loadlock port 303 coupled to the process chamber port 201. In one embodiment, the loadlock port 303 can be coupled to the process chamber port 201 to permit the interior of the process chamber 101 to communicate with the interior of the loadlock chamber 301 while preventing debris (e.g., dust, air, moisture, etc.) from undesirably entering into the interiors of the process chamber 101 and the loadlock chamber 301. The loadlock chamber 301 may also be coupled to one or more substrate cassette (not shown). In one embodiment, the loadlock chamber 301 may be configured to post-process (e.g., heat, etc.) substrates that have been processed by the process chamber 101. In another embodiment, the loadlock chamber 301 may be configured to pre-process (e.g., heat, etc.) substrates that have not been processed by the process chamber 101.

As exemplarily illustrated, the transfer robot 302 is provided as a “dual-arm” transfer robot and includes a first end effector 304 and a second end effector 306 disposed below the first end effector 304. Although FIG. 3 illustrates the first end effector 304 as supporting a substrate 305, it will be appreciated that the second end effector 306 can also support a substrate. The substrate 305 can be provided as any type of substrate capable of being processed within the process chamber 101. For example, the substrate 305 may be provided as a semiconductor substrate (e.g., a Si substrate, a GaN substrate, or the like), an insulating substrate (e.g., a glass substrate, a polymer substrate, or the like), a tape frame assembly incorporating a substrate, or the like. In one embodiment, the transfer robot 302 is provided as a single-axis robot, configured to move in a horizontal direction to simultaneously insert the first end effector 304 and the second end effector 306 into the process chamber 101. By providing the transfer robot 302 as a single-axis transfer robot, the size of the loadlock chamber 301 can be made relatively small to increase the efficiency with which substrates are post- and pre-processed. Generally, the positions of the first end effector 304 and the second end effector 306 on the transfer robot 302 are selected such that, when the first end effector 304 and the second end effector 306 are inserted into the process chamber 101, the first end effector 304 is disposed at a level corresponding to the first transfer region and the second end effector 306 is disposed at a level corresponding to the second transfer region. It will nevertheless be appreciated that the transfer robot 302 may be configured differently in any manner desired to permit any number of end effectors to be inserted into (and removed from) the process chamber 101.

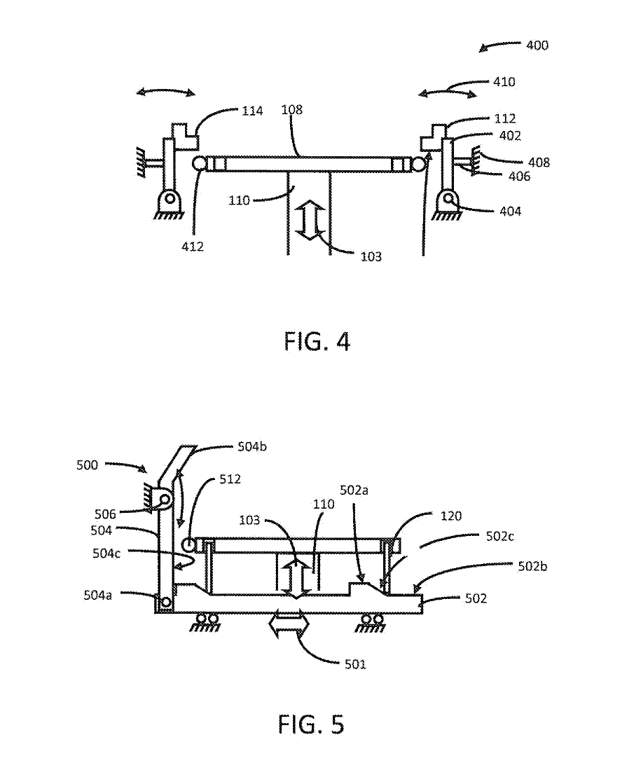

FIG. 4 is a front view schematically illustrating an upper support actuation system according to one embodiment.

Referring to FIG. 4, an upper support actuation system may, according to one embodiment, be provided as upper support actuation system 400. The upper support actuation system 400 may include plurality of first linkage arms 402, wherein each first linkage arm 402 includes a first portion coupled to a corresponding upper substrate support 112. The upper support actuation system 400 may further include a first linkage arm support 404 pivotally coupled a second portion of each first linkage arm 402, wherein the second portion of each first linkage arm 402 is spaced apart from the first portion thereof. The upper support actuation system 400 may further include a spring 406 (e.g., a compression spring) coupled between each first linkage arm 402 and a spring support 408. Each first linkage arm support 404 and spring support 408 may, in turn, be positionally fixed within the process chamber 101 by, for example, one or more frames (not shown). As also shown in FIG. 4, the substrate elevator system 106 is configured to move the upper substrate supports 112 from the first upper support position (illustrated) to the second upper support position along a direction exemplarily indicated by arrows 410. For example, the substrate elevator system 106 may further include engagement members such as engagement member 412 coupled to the substrate stage 108. In one embodiment, the engagement member 412 is movably (e.g., rotatably) coupled to the substrate stage 108. In one embodiment, the engagement member 412 is provided as a roller bearing.

Constructed as described above, the engagement members 412 contact a lower portion of the upper substrate supports 112 and push the upper substrate supports 112 away from the first upper support position as the stage elevator 110 moves the substrate stage 108 upward along a direction indicated by arrow 103. Due to the configuration of the first linkage arms 402 and first linkage arm supports 404, the engagement members 412 push the upper substrate supports 112 along a direction indicated by arrows 410 to a second upper support position in which the springs 406 are compressed. As the stage elevator 110 then moves the substrate stage 108 either further upward along a direction indicated by arrow 103 or back downward along an opposite direction indicated by arrow 103, the spring 406 exerts a restoring force on the upper substrate supports 112 to bias the upper substrate supports 112 back toward the first upper support position. When the stage elevator 110 moves the substrate stage 108 downwards from a location above the upper support level L1, the engagement members 412 contact a portion of the upper substrate supports 112 (e.g., at the support surface 114) and push the upper substrate supports 112 away from the first upper support position as the stage elevator 110 moves the substrate stage 108 downward along a direction indicated by arrow 103.

It will be appreciated that the upper support actuation system 400 and/or the substrate elevator system 106 may be configured differently in any manner desired to permit any of the upper substrate supports 112 to move relative to the substrate stage 108. For example the spring 406 and spring support 408 may be omitted and a torsion spring may be coupled between the first linkage arm support 404 and the first linkage arm 402. In another example, the engagement member 412 may be movably coupled to a lower portion of the upper substrate supports 112 or the first linkage arm 402 and a supplemental engagement member (not shown) such as a plate, a cam, or the like, can be coupled to the substrate stage 108 to contact the engagement member 412 to push the upper substrate supports 112 along the direction indicated by arrows 410 to the second upper support position as discussed above.

FIG. 5 is a side view schematically illustrating a lower support actuation system according to one embodiment.

Referring to FIG. 5, a lower support actuation system may, according to one embodiment, be provided as lower support actuation system 500. The lower support actuation system 500 may include a cam plate 502 having a surface with a support surface region 502a, a transfer surface region 502b, and a transition surface region 502c extending between the support surface region 502a and the a transfer surface region 502b. The cam plate 502 disposed under the lower substrate supports 120 and is movable (e.g., translationally movable) relative to the lower substrate supports 120 (e.g., along the directions indicated by arrow 501). In one embodiment, the cam plate 502 is supported by one or more structures such as a linear bearing, a roller bearing, a rail, or the like or a combination thereof to facilitate translational movement relative to the lower substrate supports 120. The lower support actuation system 500 may further include a second linkage arm 504 having a first portion 504a pivotally coupled to the cam plate 502. A second portion 504b may be configured to engage a portion of the substrate elevator system 106 (e.g., an engagement member 512). The engagement member 512 may be provided in any manner as exemplarily discussed above with respect to the engagement member 412. The lower support actuation system 500 may further include a second linkage arm support 506 pivotally coupled to a third portion of the second linkage arm 504 between the first and second portions 504a and 504b of the second linkage arm 504. The second linkage arm support 506 may, in turn, be positionally fixed within the process chamber 101 by, for example, one or more frames (not shown).

Constructed as described above, the engagement member 512 contacts the second portion 504b of the second linkage arm 504 as the stage elevator 110 moves the substrate stage 108 upward along a direction indicated by arrow 103. Upon contact by the engagement member 412, the second linkage arm 504 pivots about the second linkage arm support 506 to a first orientation which, in turn, causes the cam plate 502 to move to the right along a direction indicated by arrow 501. In some embodiments, the second linkage arm 504 can remain in the first orientation even if the stage elevator 110 moves the substrate stage 108 further upward along a direction indicated by arrow 103 or downward along an opposite direction indicated by arrow 103. As the cam plate 502 moves, the transition surface region 502c and the support surface region 502a are sequentially slid beneath the lower substrate supports 120 to push the lower substrate supports 120 upwards from the second lower support portion (illustrated) to the first lower support portion.

When a portion of an end effector (not shown) is disposed within the second transfer region as discussed above (i.e., when the lower substrate supports 120 are disposed at the first lower support position such that ends 122 of the lower substrate supports 120 are disposed at the lower support level L2 and when the substrate stage 108 is moved to the transfer level L4), the an engagement portion of an end effector (not shown) may contact a surface region 504c of the second linkage arm 504. Upon contacting the surface region 504c by the engagement portion of the end effector, the second linkage arm 504 pivots about the second linkage arm support 506 to a second orientation which, in turn, causes the cam plate 502 to move to the left along an opposite direction indicated by arrow 501. In some embodiments, the second linkage arm 504 can remain in the second orientation even if the end effector is removed from the second transfer region. As the cam plate 502 moves, the transition surface region 502c and the transfer surface region 502b are sequentially slid beneath the lower substrate supports 120 to allow the lower substrate supports 120 to lower (e.g., under the influence of gravity) downward from the first lower support portion to the second lower support portion.

It will be appreciated that the lower support actuation system 500 and/or the substrate elevator system 106 may be configured differently in any manner desired to permit any of the lower substrate supports 120 to move relative to the substrate stage 108. For example, the engagement member 512 may be movably coupled to the second portion 504b of the second linkage arm 504 and a supplemental engagement member (not shown) such as a plate, a cam, or the like, can be coupled to the substrate stage 108 to contact the engagement member 512 such that the second linkage arm 504 pivots about the second linkage arm support 506 to the first orientation as discussed above.

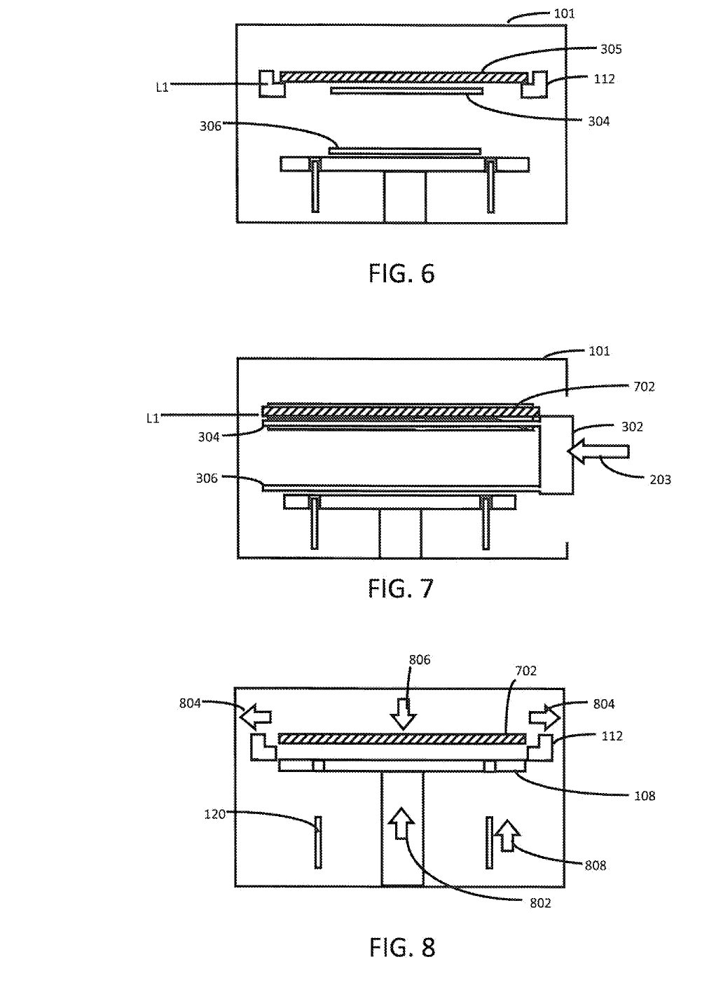

Having exemplarily described constructions of the substrate transfer apparatus according and transfer robot according to some embodiments, exemplary methods of transferring substrates will now be described with reference to FIGS. 6 to 12.

FIGS. 6 and 7 schematically illustrate one embodiment of a method of transferring a substrate from an end effector onto the upper substrate support system in the substrate transfer apparatus shown in FIGS. 1 and 2.

Referring to FIGS. 6 and 7, the transfer robot 302 is operated to insert the first end effector 304 and the second end effector 306 into the process chamber 101 as described above, wherein the first end effector 304 supports a substrate 702 to be processed by the process chamber 101. Substrate 702 may be provided as any suitable substrate as exemplarily described above with respect to substrate 305. As shown, the substrate 702 is introduced into the process chamber, along the direction indicated by arrow 203 and is supported by the first end effector 304 at a level below the upper support level L1. A width of the first end effector 304 is less than a distance between the upper substrate supports 112 disposed at their respective first upper support positions, but the width of the substrate 702 is greater than the distance between the upper substrate supports 112. Accordingly, the substrate 702 contacts the transfer surfaces 118 of the upper substrate supports 112 as the first end effector 304 moves between the upper substrate supports 112. Upon contacting the transfer surfaces 118 of the upper substrate supports 112, the substrate 702 is deflected above the upper support level L1 and over the support surface 114 where it eventually falls onto the support surface 114 at the upper support level L1 as described above with respect to FIGS. 1 and 2. Thus, the substrate 702 is transferred from the first end effector 304 at a level below the upper support level L1 to the support surface 114 at the upper support level L1 simply upon moving the transfer robot 302 along the direction indicated by arrow 203. The transfer robot 302 can thereafter be operated to remove the first end effector 304 and the second end effector 306 from the process chamber 101.

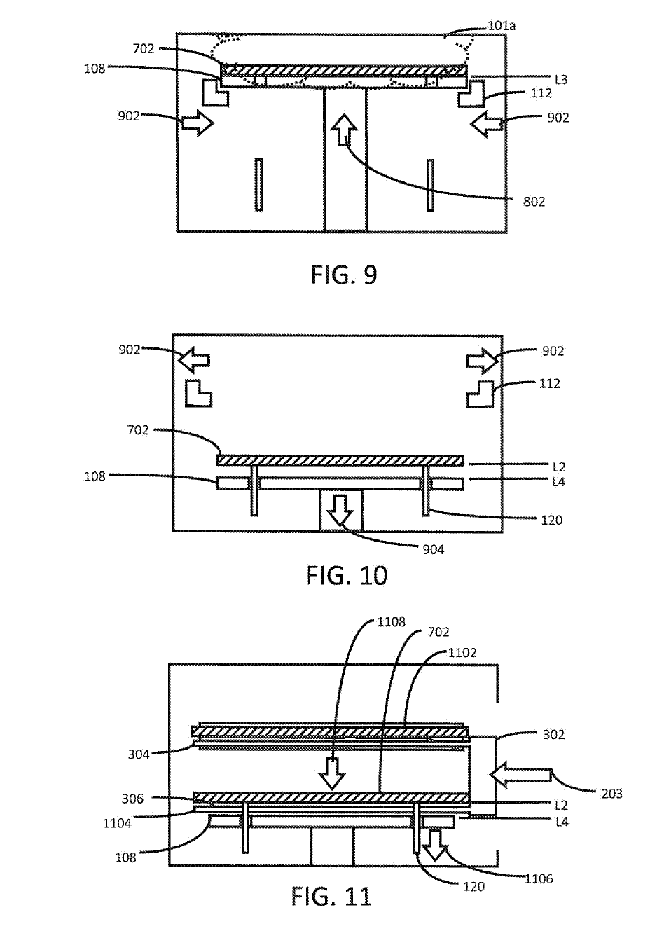

FIGS. 8 and 9 schematically illustrate one embodiment of a method of transferring a substrate from the upper substrate support system to a process region of a process chamber.

Referring to FIG. 8, the substrate stage 108 is moved upwards (e.g., along the direction indicated by arrow 802) and the upper substrate supports 112 are moved from their respective first upper support positions (illustrated) toward respective second upper support positions (e.g., along directions indicated by arrows 804). In one embodiment, the substrate stage 108 and the upper substrate supports 112 can be variously moved as exemplarily described above. In one embodiment, the substrate 702 falls (e.g., along the direction indicated by arrow 806) onto the substrate stage 108 as the upper substrate supports 112 move toward the second upper support position. In one embodiment, the upper substrate support system 102 and the substrate elevator system 106 can be configured such that the distance which the substrate 702 falls is less than 30 mm. For example, the upper substrate support system 102 and the substrate elevator system 106 can be configured such that the substrate 702 falls less than 20 mm. In another example, the upper substrate support system 102 and the substrate elevator system 106 can be configured such that the substrate 702 falls less than 10 mm. Also, as the substrate stage 108 moves upward toward the upper support level L1, the lower support pins 120 can be moved to the first lower support position (e.g., from the second lower support position) as exemplarily described above.

Referring to FIG. 9, the falling substrate 702 is intercepted by the substrate stage 108. The substrate stage 108 is then moved upwards (e.g., along the direction indicated by arrow 802) to the process level L3, where the substrate 702 is disposed within the process region 101a and can be processed by the process chamber 101. In one embodiment, the upper substrate supports 112 are moved from their respective second upper support positions back toward respective first upper support positions (e.g., along directions indicated by arrows 902). In one embodiment, the substrate stage 108 and the upper substrate supports 112 can be variously moved as exemplarily described above.

FIGS. 10 to 12 schematically illustrate one embodiment of a method of transferring a substrate from the substrate elevator system in the substrate transfer apparatus shown in FIGS. 1 and 2 to an end effector.

Referring to FIG. 10, the upper substrate supports 112 are moved to their respective second upper support positions (e.g., along the directions indicated by arrows 902), and the substrate stage 108 is moved downwards (e.g., along the direction indicated by arrows 904) to the transfer level L4 such that the lower substrate supports 120 intercept the substrate 702 and support the substrate at the lower support level L2 above the second transfer region defined between the lower support level L2 and the transfer level L4. In one embodiment, the substrate stage 108 and the upper substrate supports 112 can be variously moved as exemplarily described above.

Referring to FIG. 11, the transfer robot 302 is operated to insert the first end effector 304 and the second end effector 306 back into the process chamber 101 as described above. In the illustrated embodiment, the first end effector 304 can support a substrate 1102 to be processed by the process chamber 101. Substrate 1102 may be provided as any suitable substrate as exemplarily described above with respect to substrate 305. In one embodiment, the substrate 1102 is pre-processed (e.g., heated, etc.) within the loadlock chamber 301 before being inserted into the process chamber 101. In another embodiment, the substrate 1102 is pre-processed while the substrate 702 is processed within the process region 101a.

As shown, the substrate 1102 is introduced into the process chamber, along the direction indicated by arrow 203 and is supported by the first end effector 304 at a level below the upper support level L1, but can eventually be supported at the upper support level L1 in the manner described above. As exemplarily illustrated, the transfer robot 302 is inserted into the process chamber such that the second effector 306 is disposed within the second transfer region defined between the lower support level L2 and the transfer level L4. Upon disposing the second effector 306 within the second transfer region, the lower substrate supports 120 are actuated (e.g., by an engagement portion 1104 of the second end effector 306, as discussed above) to move downwards (e.g., along the direction indicated by the arrow 1106) to the second lower support position. As a result, the substrate 702, which was processed by the process chamber 101, can move downwards (e.g. along the direction indicated by the arrow 1108) to be supported by the second end effector 306.

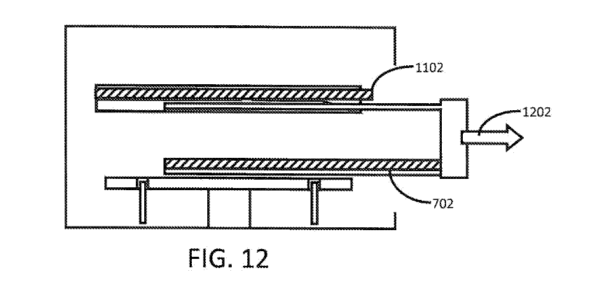

Thereafter, and as shown in FIG. 12, the transfer robot 302 can be removed from the process chamber 101 (e.g., along the direction indicated by arrow 1202) to transfer the substrate 702 into the loadlock chamber 301, leaving the substrate 1102 to be processed (e.g., within the process region 101a) and moved and supported within the process chamber 101 as exemplarily described above. In one embodiment, the substrate 702 can be post-processed (e.g., heated, etc.) within the loadlock chamber 301 after being transferred into the loadlock chamber 301. In another embodiment, the substrate 702 is post-processed while the substrate 1102 is processed within the process region 101a.

Having described various apparatuses and methods above, it will be appreciated that embodiments of the present invention may be implemented and practiced in many different forms. For example, a substrate transfer apparatus of a process chamber may include one or more substrate supports. Each substrate support may include a support surface disposed at a support level and a transfer surface extending downwards from the support level to define a transfer region. The transfer surface may be configured to engage a substrate inserted into the process chamber by an end effector at a level below the support level so as to deflect the substrate above the support level and over the support surface such that the substrate can subsequently be placed onto the support surface and supported at the support level.

In another example, a substrate transfer apparatus may include an upper substrate support system including at least one upper substrate support configured to support a substrate at a upper support level; a lower substrate support system including at least one lower substrate support configured to support the substrate at a lower support level below the upper support level; and a substrate elevator system including a substrate stage configured to support the substrate, wherein the substrate elevator system is configured to move the substrate stage between the upper support level and the lower support level, wherein the upper substrate support system and the substrate elevator system are configured such that the substrate is transferrable from the at least one upper substrate support to the substrate stage, and wherein the lower substrate support system and the substrate elevator system are configured such that the substrate is transferrable from the substrate stage to the at least one lower substrate support.

The foregoing is illustrative of embodiments of the invention and is not to be construed as limiting thereof. Although a few example embodiments of the invention have been described, those skilled in the art will readily appreciate that many modifications are possible in the example embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific example embodiments of the invention disclosed, and that modifications to the disclosed example embodiments, as well as other embodiments, are intended to be included within the scope of the appended claims. The invention is defined by the following claims, with equivalents of the claims to be included therein.

What is claimed is:

1. A substrate transfer apparatus, the substrate transfer apparatus comprising:
an upper substrate support system configured to be disposed within a substrate process chamber, the upper substrate support system including at least one upper substrate support configured to support a substrate at a upper support level;
a lower substrate support system including at least one lower substrate support configured to support the substrate at a lower support level below the upper support level; and
a substrate elevator system including a substrate stage configured to support the substrate, wherein the substrate elevator system is configured to move the substrate stage between the upper support level and the lower support level,
wherein the upper substrate support system and the substrate elevator system are configured such that the substrate is transferrable from the at least one upper substrate support to the substrate stage, and
wherein the lower substrate support system and the substrate elevator system are configured such that the substrate is transferrable from the substrate stage to the at least one lower substrate support.

2. The apparatus of claim 1, wherein the at least one upper substrate support includes:
a support surface disposed at the upper support level; and
a transfer surface extending downwards from the upper support level upper to define a first transfer region configured to engage a substrate inserted into the process chamber by an end effector, wherein the transfer surface is disposed at an angle, α, relative to the support surface, wherein α, is greater than 90 degrees and less than 180 degrees.

3. The apparatus of claim 2, wherein a is greater than 110 degrees and less than 160 degrees.

4. The apparatus of claim 1, wherein the at least one upper substrate support is movable relative to the substrate stage from a first upper support position in which the substrate is supportable at the upper support level to a second upper support position in which the substrate is transferrable to the substrate stage.

5. The apparatus of claim 4, wherein the substrate elevator system is configured to move the at least one upper substrate support to the second upper support position.

6. The apparatus of claim 5, wherein the substrate elevator system comprises an engagement member movably coupled to the substrate stage, wherein the engagement member is configured to contact the at least one upper substrate support.

7. The apparatus of claim 5, wherein the upper substrate support system includes an upper support actuation system configured to move the at least one upper substrate support from the second upper support position to the first upper support position.

8. The apparatus of claim 7, wherein the upper support actuation system includes:
a first linkage arm having a first portion coupled to the at least one upper substrate support;
a first linkage arm support pivotally coupled to a second portion of the first linkage arm spaced apart from the first portion of the of the first linkage arm; and
a spring coupled to the first linkage arm;
wherein the first linkage arm, first linkage arm support and spring are configured such that the spring exerts a restoring force on the at least one upper substrate support when the at least one upper substrate support is at the second upper support position to bias the at least one upper substrate support toward the first upper support position.

9. The apparatus of claim 1, wherein
the process chamber includes a process region and is configured to process the substrate when the substrate is disposed within the process region, and
the substrate elevator system is further configured to move the substrate stage above the upper support level to a process level, wherein the substrate is disposable within the process region when the substrate stage is at the process level.

10. The apparatus of claim 1, wherein
the substrate elevator system is configured to move the substrate stage to a transfer level below the lower support level,
a second transfer region is definable between the transfer level and the lower support level, and
the at least one lower substrate support is configured such that a portion of an end effector is receivable within the second transfer region.

11. The apparatus of claim 10, wherein the at least one lower substrate support is movable relative to the substrate stage from a first lower support position in which the substrate is supportable at the lower support level to a second lower support position below the second transfer region.

12. The apparatus of claim 11, wherein the second lower support position is below the transfer level.

13. The apparatus of claim 11, wherein the lower substrate support system includes a lower support actuation system actuatable to move the at least one lower substrate support between the first lower support position and the second lower support position.

14. The apparatus of claim 13, wherein the substrate elevator system is configured to actuate the lower support actuation system to move the at least one lower substrate support from the second lower support position to the first lower support position.

15. The apparatus of claim 13, wherein the lower support actuation system is actuatable to move the at least one lower substrate support from the first lower support position to the second lower support position when the portion of the end effector is received within the second transfer region.

16. The apparatus of claim 13, wherein the lower support actuation system includes:
a cam plate including a surface having a support surface region, a transfer surface region and a transition surface region extending between the support surface region and the transfer surface region, wherein the cam plate is linearly movable relative to the at least one lower substrate support; and
a second linkage arm having a first portion coupled to the cam plate and a second portion configured to engage a portion of the substrate elevator system; and
a second linkage arm support pivotally coupled to a third portion of the second linkage arm spaced apart from the first and second portions of the of the second linkage arm.

17. A method of transferring substrates, comprising
providing a process chamber having a first substrate support system and a second substrate support system within an interior thereof, wherein each of the first substrate support system and second substrate support system are configured to support a substrate;
transferring a first substrate onto the first substrate support system such that the first substrate is supported by the first substrate support system;
inserting a first end effector supporting a second substrate into the process chamber such that the first substrate, first end effector and second substrate are simultaneously disposed within the process chamber;
inserting a second end effector into the process chamber such that the first substrate, first end effector, second substrate and second end effector are simultaneously disposed within the process chamber;
transferring the first substrate onto the second end effector;
removing the first end effector from the process chamber after transferring the second substrate onto the first substrate support system; and
removing the second end effector from the process chamber after transferring the first substrate onto the second end effector.

18. The method of claim 17, wherein inserting the first end effector into the process chamber and inserting the second end effector into the process chamber is performed simultaneously.

19. The method of claim 17, wherein removing the first end effector from the process chamber and removing the second end effector from the process chamber is performed simultaneously.
